(19) United States
(12) Patent Application Publication
(10) Pub. No.: US 2010/0154453 A1
(43) Pub. Date: Jun. 24, 2010

(54) LINE SET BOX FOR PROTECTING REFRIGERANT LINES AND METHOD OF USE THEREOF

(76) Inventor: KELLY P. WINKLER, Cartersville, GA (US)

Correspondence Address: Woodcock Washburn LLP, Cira Centre, 12th Floor, 2929 Arch Street, Philadelphia, PA, 19104-2891, US

(21) Appl. No.: 12/338,009

(22) Filed: Dec. 18, 2008

(51) Int. Cl. F25D 23/00; B23P 19/04

(52) U.S. Cl. 62/259.1; 29/700

(57) ABSTRACT

A line set box, and a method of use thereof, comprising a generally rigid conduit box panel having a removable front cover, wherein the box panel has knockouts and insertable sealing grommets enabling sealed passage of conduits from inside a structure to outside the structure. Thus, the conduit box functions to house and protect end portions of refrigerant lines, drain lines, and/or control lines of an air-conditioning system during construction of a building until the refrigerant lines and the control lines are connected to a compressor of the air-conditioning system located outside the building.

### PRIORITY CLAIM TO RELATED US APPLICATIONS

To the full extent permitted by law, the present United States Non-Provisional patent application claims priority to and the full benefit of United States Provisional patent application entitled “Line Set Box for Protecting Refrigerant Lines and Method of Use Thereof”, filed on Dec. 20, 2007, having assigned Ser. No. 61/008,373, incorporated entirely herein by reference.

### TECHNICAL FIELD

The present line set box relates generally to devices for structures, and more specifically a line set box for protecting heating, ventilation, and air-conditioning refrigerant lines during construction.

### BACKGROUND

Modern heating, ventilation, and air-conditioning (HVAC) systems control the temperature, humidity, and movement of indoor air in residential and commercial buildings. Central air conditioners are typically used for larger residential buildings and commercial buildings, verses window-mounted units which are used to heat and/or cool individual rooms or apartments within a building. A central air conditioner offers a more efficient way to cool such larger indoor spaces, or zones of space by providing controlled flow of cooled/heated air through air ducts of a conventional forced-air heating/cooling system. Such a system cools the indoor air during conditions of warm outside temperatures and heats the indoor air during conditions of cold outdoor air temperatures to maintain a desired indoor air temperature.

As is known, central air conditioners include a compressor, typically installed outside the residential house or commercial building, and a condenser, typically located inside the building or residence, making up a conventional forced air heating and ventilation system. Typically, the compressor of the central air conditioner is placed on a concrete pad located outside the residential house or commercial building. The compressor is connected to the condenser located inside the house by a number of air-conditioning lines/conduits, which extend through a section of an exterior wall of the house or commercial building and run through the internal walls, floors and attic to the condenser. More specifically, two refrigerant lines (typically copper lines for supplying/returning a refrigerant gas), a drain line (for drainage of condensation collected under the condenser) and a control line (electrical line for selectively activating the compressor and fan of the air-conditioning system) extend between the outside-located compressor and the inside-located condenser of the forced-air heating and cooling system.

As specifically illustrated in FIG. 1, hole 10 is cut in exterior wall 12 leading to the inside of the house or building and is typically utilized in the prior art for allowing refrigerant lines 14, drain line 15, and control line 16 through exterior wall 12 of residential house or commercial building 18. By providing such access through exterior wall 12, refrigerant lines 14, drain line 15, and control line 16 may be run through hole 10 for extension between a set of air conditioner compressor and the condenser.

However, due to the relatively large size of hole 10, refrigerant lines 14, drain line 15, and control line 16 passing therethrough fail to substantially fill hole 10, leaving hole 10 substantially unfilled or open. This makes the inside of residential house or commercial building 18 very vulnerable to infiltration of undesirable exterior elements such as air, moisture, mold, bacteria, insects, rodents, and the like, from the outside. As will be recognized, this poses a significant problem since the infiltration of air, moisture, mold, bacteria, insects, rodents, and the like, may damage the structural integrity and/or the aesthetic appearance of residential house or commercial building 18, and poses a substantial health risk to occupants.

In an attempt to alleviate this problem of an unsealed aperture into residential house or commercial building 18, a common practice in the field has been to simply push rag or fabric matting 17 around the lines in an effort to fill or seal off hole 10. Alternatively, when brick veneer is included on residential house or commercial building 18, it has been a common practice in the field to simply place additional mortar around refrigerant lines 14, drain line 15, and control line 16 in an effort to fill or seal off hole 10. As another alternative method, foam spray, caulk sealants, tar, or the like, may be used to fill or seal-off hole 10.

Additionally as background, an exterior wall mount flashing having a flush surface with one or more aperture(s) for receiving air-conditioning lines therethrough may be applied to an exterior wall of a building. Such flashing panel mount typically provides a plurality of apertures adapted to receive a bundle of refrigerant and/or electrical control lines of an air-conditioning system through a wall of a residential or commercial building, so as to eliminate any access into the building by unwanted intrusions such as water, rodents, or the like.

However, in view of the present line set box, the background set forth in FIG. 1 and the exterior wall mount flashing apparatus are deficient in many ways. Specifically, neither option provides a secure space in which to recoil the installed refrigerant, drain and control lines during the remaining phases of construction, when unprotected refrigerant, drain and control lines are likely to be damaged or broken due to exposure to hazards. If the refrigerant lines are damaged or broken during final stages of construction, a considerable amount of time and money is then required to repair the damaged or broken refrigerant, drain and control lines. If soldering is necessary to repair the damaged refrigerant lines, such soldering creates a risk of fire to the structure, especially when combustible construction debris is present at the construction site.

Therefore, it is readily apparent that there is a recognizable need for a line set box, and a method of use thereof, that functions to enclose and protect the end portions of the refrigerant, drain and control lines during final phases of construction until such refrigerant, drain and control lines are connected to the compressor of the central air conditioner system, and that provides a plurality of apertures having sealing grommets adapted to receive a selected one of the refrigerant, drain and control lines to eliminate any unwanted infiltration such as air, water, mold, bacteria, rodents, insects, and the like.

### BRIEF DESCRIPTION

Briefly described in a preferred embodiment, the present apparatus, device, method and system overcomes the above-mentioned disadvantages and meets the recognized need for such a device by providing a line set box, and method of use thereof, comprising a generally rigid conduit box having a removable front cover, wherein the conduit box includes knockouts with insertable sealing grommets enabling the sealed passage of conduits from inside a structure to outside the structure, and, thus, functions to house and protect the end portions of refrigerant lines, drain lines, and control lines during remaining phases of construction until refrigerant lines, drain line, and control line are connected to the compressor of the central air conditioner system located outside the residential house or commercial building.

According to its major aspects and broadly stated, the present line set box in its preferred form is a generally rigid box attached to the structure between wall studs forming an exterior wall, a plurality of differently-sized knockouts forming apertures having insertable sealing grommet to allow the passage of one or more line(s) of a central air conditioner, such as a refrigerant line, a drain line, and a control line, a removable front cover for securing the coiled end portions of the lines during remaining phases of construction, and a removable toe cover enabling the passage of one or more line(s) of the central air conditioner from the box for permanent connection to the compressor of the central air conditioner system located outside the structure.

Accordingly, a feature of the present line set box is its ability to enclose and protect one or more line(s) of the central air conditioner from damage during remaining stages of construction of the structure.

Another feature and advantage of the present line set box is its ability to create an enclosure in which the one or more line(s)may be coiled upon installation of the line(s) during the rough build phase of construction, in which the line(s) may be protected through close-in of the structure, insulation and dry wall installation, exterior finishing and back filling around the foundation, when such lines are otherwise likely to be damaged or broken off.

Still another feature and advantage of the present line set box is its ability to provide a plurality of apertures with sealing grommets adapted to receive one or more line(s) of the central air-conditioning system through a wall of a residential or commercial building, in order to eliminate unwanted infiltration of air, water, mold, bacteria, insects, rodents and/or the like.

Yet another feature and advantage of the present line set box is its ability to create a passageway for air conditioning lines/conduits running from the outside compressor to the condenser located inside the house extending through a portion of an exterior wall of the building.

These and other features and advantages of the present line set box will become more apparent to those ordinarily skilled in the art from the following description and claims when read in light of the accompanying drawings.

### BRIEF DESCRIPTION OF THE DRAWINGS

The present version of the line set box will be better understood by reading the Detailed Description of the Preferred and Selected Alternative Embodiments with reference to the accompanying drawing figures, in which like reference numerals denote similar structure and refer to like elements throughout, and in which:

FIG. 1 is a perspective view of a prior-art hole bored through an exterior wall with refrigerant lines, a drainage line, and a control line exiting the residential or commercial building therethrough;

FIG. 2 is an exploded perspective view of a rigid line set box having a removable front cover and panel knockouts for enclosing and protection one or more set(s) of lines of a central air-conditioning system;

FIG. 3 is a partial cross-sectional view of the apertures of the line set box shown in FIG. 2 and illustrating a plurality of sealing members each positioned around their respective apertures;

FIG. 4 is a perspective view of a line set box mounted between two studs with refrigerant lines, a drainage line and a control line coiled inside the box panel according to a preferred embodiment;

FIG. 5 is a perspective view of a line set box mounted between two studs with refrigerant lines, drainage line and control line passing from an interior of a building to the exterior according to an alternate embodiment;

FIG. 6 is a perspective view of a line set box with refrigerant lines, drainage line and control line passing from an interior of a building to the exterior wherein the exterior is a wood or composite siding according to an alternate embodiment; and

FIG. 7 is a perspective view of a line set box panel with refrigerant lines, drainage line and the control line passing from an interior of a building to the exterior wherein the exterior is a brick or masonry veneer according to an alternate embodiment.

### DETAILED DESCRIPTION OF THE PREFERRED AND SELECTED ALTERNATIVE EMBODIMENTS

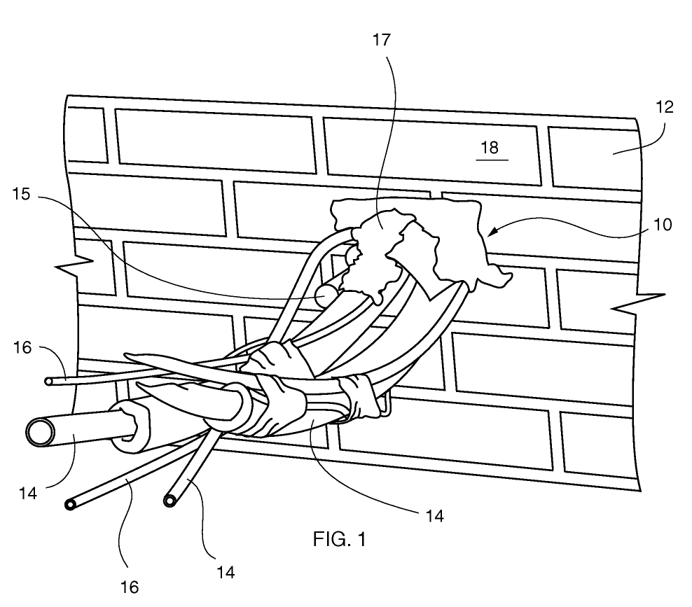

In describing the preferred and selected alternative embodiments of the present line set box, as illustrated in FIGS. 1-7, specific terminology is employed for the sake of clarity. The line set box is not, however, intended to be limited to the specific terminology so selected, and it is to be understood that each specific element includes all technical equivalents that operate in a similar manner to accomplish a similar function.

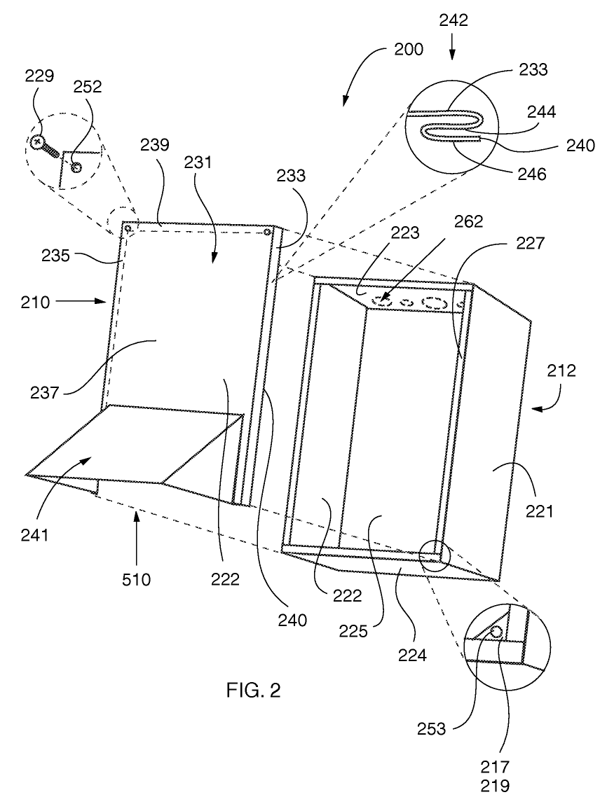

Referring now to FIG. 2, by way of example, and not limitation, there is illustrated a perspective view of line set box 200 in accordance with a preferred embodiment of the present line set box. Preferably, line set box 200 comprises a front panel 210 and rear housing 212, such rear housing 212 having side walls 221 and 222, top wall 223, bottom wall 224, and back wall 225 configured in the shape of a rectangular box. It is contemplated that configurations other than a rectangular are contemplated herein, including, without limitation a cubic, polygonal or other shape. Front panel 210 and rear housing 212, including side walls 221 and 222, top wall 223, and bottom wall 224, each have rolled edges 227 are preferably formed of a suitable material, such as sheet metal, plastic, rubber, wood, composite material, or the like, such as via a stamping or molding procedure as commonly known in the art, and are capable of providing structure to line set box 200. Preferably, the suitable material includes other desirable characteristics, such as high durability, water resistance, light weight, heat resistance, corrosion resistance, ease of workability, or other desirable characteristic, as understood by those ordinarily skilled in the art.

Front panel 210 is preferably formed as a removable protective access cover, comprising cover 231 and toe section 241. Cover 231 preferably comprises front 237, side walls 233 and 235, and top wall 239 arranged in a rectangular box, each wall having edges 240. Side walls 233 and 235 and top wall 239 of cover 231 preferably fit over rolled edges 227 of rear housing 212 to releasably affix cover 231 of front panel 210 to rear housing 212 forming a protective enclosure for refrigerant lines 14, drain line 15, and control line 16. Preferably, front panel 210 is removably affixed to rear housing 212, such as by a frictional fit between front panel 210 and rear housing 212.

It is contemplated in an alternate embodiment that edge 240 of front panel 210 may include an article retaining means, such as flange 242. Flange 242 may include first rolled member 244 and second rolled member 246, preferably rolled, folded and pressed into edge 240 of side walls 233, 235, and top wall 239 for receiving an unrolled edge 227 of side walls 221 and 222, top wall 223 of rear housing 212.

It is contemplated in still another alternate embodiment that front panel 210 may include pre-drilled holes 252, enabling cover 231 to be affixed to rear housing 212 by fasteners 229 such as a metal screw, threaded screw, nut and bolt, clip or other fasteners known to those having ordinary skill in the art.

It is contemplated in still another alternate embodiment that front panel 210 may be secured to rear housing 212 by any other suitable means, including, but not limited to, an alternate embodiment wherein side walls 221 and 222 include bent tab portions 217 and 219, respectively, which have holes 253 formed therein. Alternatively, bent tabs may be provided on the top 223 and bottom 224 walls. Top wall 223 may include bent tab portions 217 and 219 which cover the upper portions of the side walls 221 and 222. Bottom wall 224 may likewise include bent tab portions 217 and 219 covering the bottom portions of side walls 221 and 222. Mechanical fasteners, press fittings, snap fittings, adhesives and the like, may be utilized to affix front panel 210 to rear housing 212. Fasteners 229 may be inserted through holes 252 in front panel 210 and seated in holes 253 of the bent tab portions 217 and 219 of rear housing 212.

It is contemplated herein that if toe section 241 were formed as a separate piece from front panel 231, toe section 241 may have similar means for releasably affixing toe section 241 to rear housing 212 as set forth herein for cover 231 of front panel 210.

Top wall 223 of rear housing 212 preferably includes several knockouts 262; however, knockouts 262 may optionally be located on side walls 211 and 212, or back wall 225 of rear housing 212. Upon removing knockouts 262 from rear housing 212, a plurality of apertures 310 may be formed, each adapted to accommodate a separate line of an air-conditioning system through a wall of a residential and/or commercial building. By providing multiple apertures, which closely fit and seal their respective air conditioning lines, drain line and/or control lines extending therethrough, the line set box 200 eliminates the need for a single enlarged opening characteristic of conventional prior art installations. Eliminating such opening effectively prevents any infiltration of unwanted material from the outside environment, such as air, water, mold, bacteria, insects, rodents, or the like.

Before proceeding with the substantive explanations of the present line set box, it is important to clarify certain terminologies used herein for the purpose of better understanding the present line set box. First, the term “residential building” used throughout this section should not be construed narrowly, but rather broadly to mean any type of facility which is intended for residential purposes. Examples of such facilities include, but are not limited to, residential houses, apartments, condominiums, cabins, trailer homes, and the like. Furthermore, the term “commercial building” should also be interpreted broadly to include any facility that is intended for purposes other than for residence such as hotels, motels, retail stores, office buildings, factory buildings, and the like.

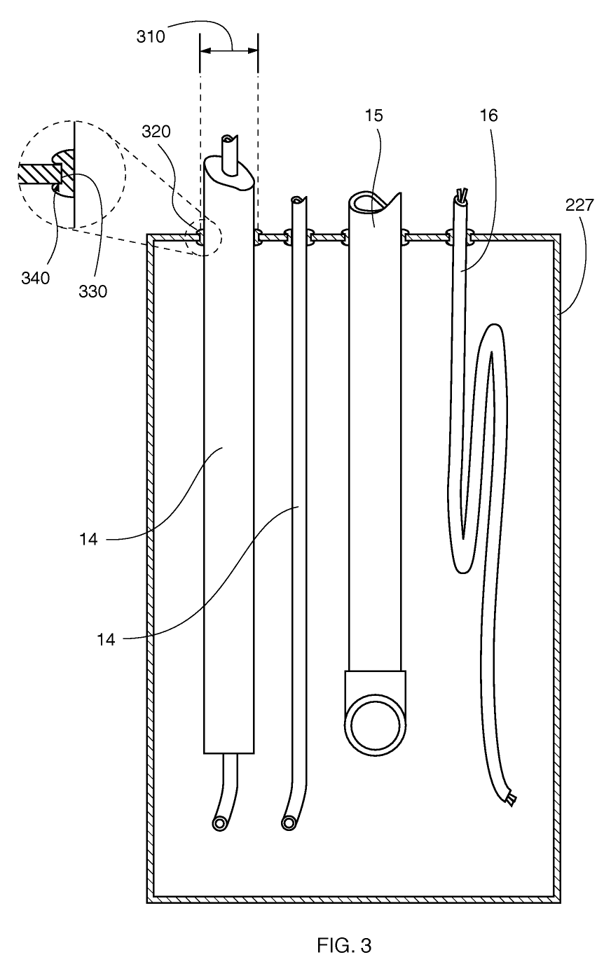

Referring now to FIG. 3, there is a cross-sectional view of apertures 310 of the line set box 200, shown in FIG. 2, and illustrating a plurality of sealing members 320, each positioned around a respective aperture 310, according to a preferred embodiment of the present line set box. Preferably, apertures 310 are formed through top wall 223 of rear housing 212, and are specifically adapted to accommodate a respective selected one of refrigerant lines 14, drain line 15, and control line 16 therethrough. Each aperture 310 provides a pathway through which one of refrigerant lines 14, drain line 15, and control line 16 may extend through top wall 223 of rear housing 212.

Although not by way of limitation, the number of apertures 310 provided is preferably identical to the number of refrigerant lines 14, drain lines 15, and control lines 16 of an associated air-conditioning system, and each is preferably adapted to accommodate a selected line of the air-conditioning system through wall 12 of residential or commercial building 18. In this respect, four panel apertures 310 are preferably included to accommodate one each of refrigerant lines 14, drain line 15, and control line 16 if an associated air-conditioning system has a single compressor located outside residential or commercial building 18 and a single evaporator located inside residential or commercial building 18. If additional lines are included with the associated air-conditioning system, then a corresponding number of additional apertures 310 are preferably included, corresponding in dimension to a respective one of the additional lines.

Each of apertures 310 is preferably sized to closely fit the diameter size of a respective one, or more, refrigerant line 14, drain line 15, and/or control line 16. Thus, apertures 310 intended to receive refrigerant lines 14 may be larger in size than another aperture 310 intended to receive a control line 16. Such sizing of each aperture 310 preferably significantly reduces any spacing between an aperture 310 and a respective refrigerant lines 14, drain line 15, and/or control line 16. This preferably reduces access from the outside environment for unwanted material, such as air, water, mold, bacteria, insects, rodents, or the like.

Moreover, each aperture 310 preferably includes a respective sealing member 320 therein to ensure an adequate seal for the respective aperture 310, while allowing the respective refrigerant line 14, drain line 15, and/or control line 16 to pass therethrough. Each sealing member 320 is preferably formed as a grommet which may be positioned around edging 330 of aperture 310. More specifically, each of the grommets has a groove 340 which captures edging 330 of a respective aperture 310, so as to fixedly engage aperture 310. Preferably, the grommets are each fabricated from an elastomeric material, such as rubber, so as to protect the structural integrity of both aperture edging 330 and a refrigerant line 14, a drain line 15, and/or a control line 16 passing therethrough. Each sealing member 320, such as a grommet, preferably substantially completely prevents infiltration of an unwanted material from an outside environment, such as air, water, mold, bacteria, insects, rodents, or the like, into the inside of residential and/or commercial building 18.

Alternatively, it should be recognized that top wall 223 of rear housing 212 may be formed of a stretchable sheet or membrane. Such sheet or membrane may be fabricated from various types of stretchable material. One type of such material is an elastomeric material, such as rubber. In such an alternative embodiment, slits or holes may be created directly through top wall 223 simulating apertures 310, and, upon stretching of such slits or holes, one of refrigerant lines 14, drain line 15, and/or control line 16 may be passed therethrough, thereby reducing the risk of infiltration of an unwanted material, such as air, water, mold, bacteria, insects, rodents, or the like, into residential and/or commercial building 18. Such slits or holes may be formed by simply cutting top wall 223 with a cutting tool, or by any other similar tool or procedure, thereby eliminating the need for sealing member 320.

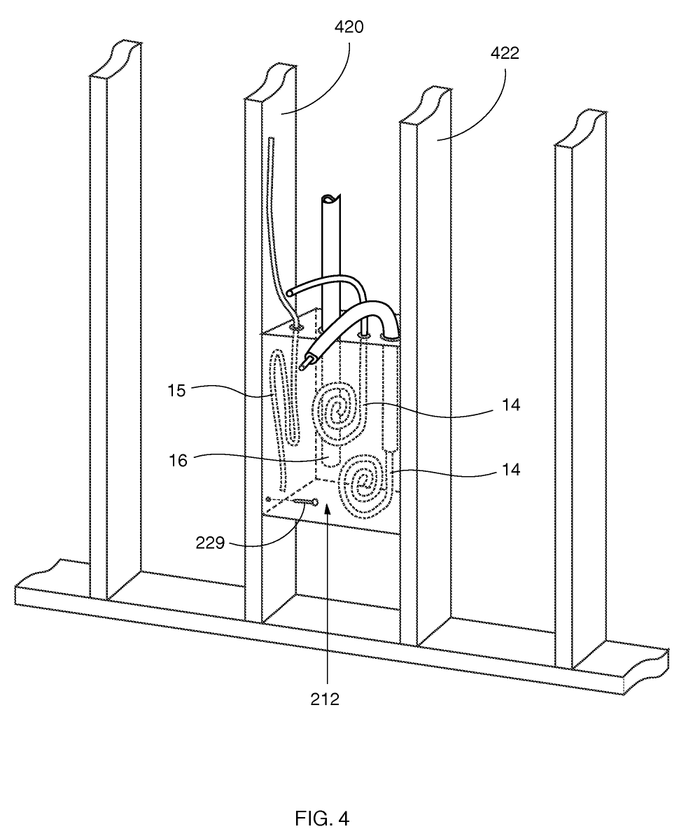

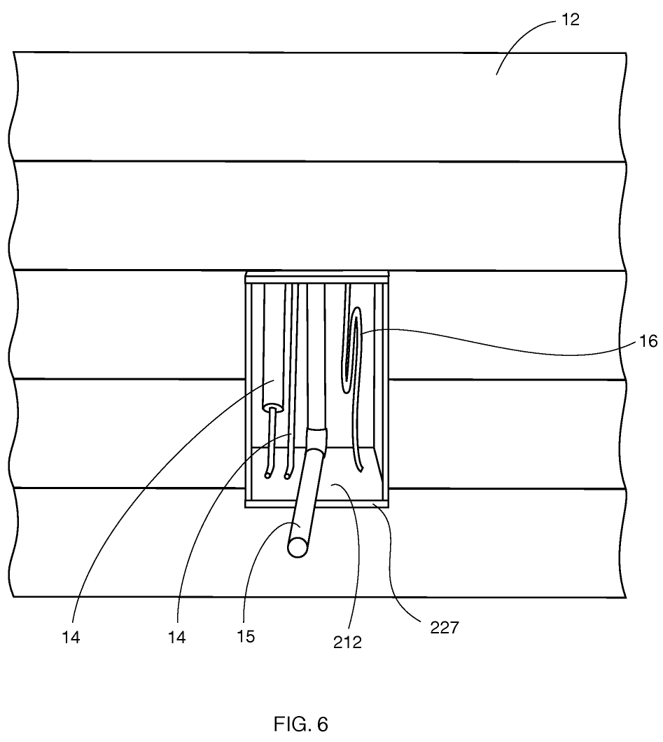

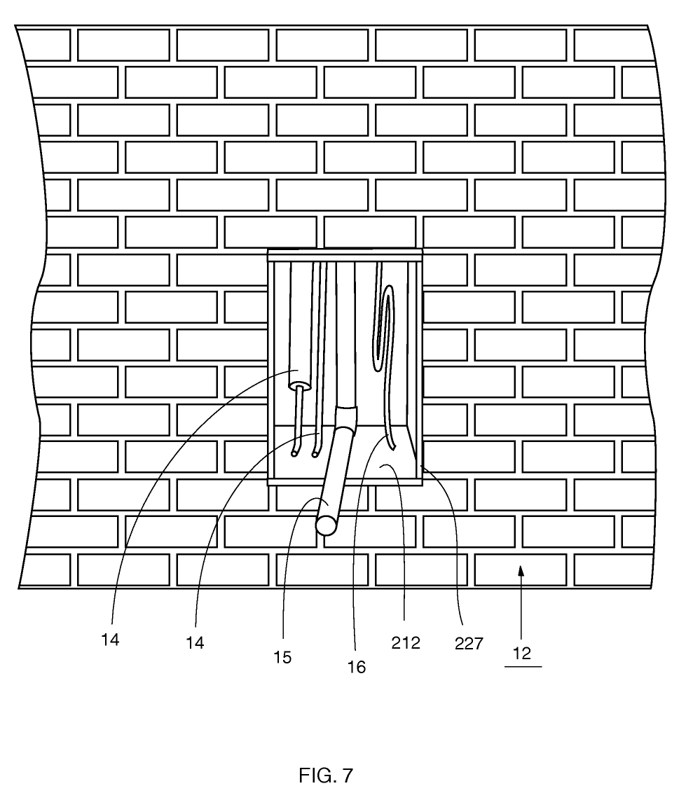

Referring now to FIG. 4, there is illustrated a perspective view of line set box 200 mounted between two studs 420, 422, with refrigerant lines 14, drainage line 15 and the control line 16 coiled inside the box panel according to a preferred embodiment of the present line set box. Preferably, line set box 200 is positioned within exterior wall 12 of residential house or commercial building 18 of a size and dimension capable of accommodating line set box 200. More particularly, side walls 221 and 222 of rear housing 212 preferably directly abut framing studs 420 and 422 of exterior wall 12 of residential house or commercial building 18, such that fasteners 229, such as nails, screws, or the like, may be used for attachment of line set box 200 to framing studs 420 and 422. Preferably, line set box 200 is mounted in the selected exterior section of residential house or commercial building 18 in a manner such that front panel 210 faces an exterior or outside of residential house or commercial building 18, and such that front panel 210 is flush with, or extends partially beyond, exterior wall 12, whether exteriorly clad with wood, vinyl, or other composite siding, as shown in FIG. 6, or whether exteriorly clad with brick or brick veneer, as shown in FIG. 7. Rear housing 212 is preferably positioned within exterior wall 12 of residential house or commercial building 18. Upon completion of the installation of line set box 200 and finishing of exterior wall 12, a weatherproof junction is preferably made between rear housing 212 of line set box 200 by inserting a silicone exterior calk into the gap between edge 227 of rear housing 212 and exterior wall 12 reducing the amount of access from the outside environment such as air, water, insects, rodents or the like from gaining access to the inside of the residential and/or commercial building 18.

In a preferred embodiment of the present line set box, refrigerant lines 14, drain line 15, and control line 16 are each inserted through a respective aperture 310 formed through top wall 223 of rear housing 212 so as to extend into rear housing 212, wherein refrigerant lines 14, drain line 15, and control line 16 may be coiled, or otherwise stored, within rear housing 212. Moreover, affixing cover 231 and toe section 241 of front panel 210 on rear housing 212 preferably protects the end portions of refrigerant lines 14, drain line 15, and control line 16 during final phases of construction, such as during the rough build phase of the construction, the close-in of the structure, the insulation and dry wall installation, and the exterior finishing and back filling around the foundation, when such refrigerant lines 14, drain line 15, and control line 16 are likely to be damaged or broken off if not so protected within line set box 200. Such protection preferably avoids a considerable amount of wasted time and money associated with repair of damaged or broken end portions of one or more line(s). In addition, such protection preferably avoids the fire hazard presented by soldering required to attach extension pieces to one or more refrigerant line 14 when broken, especially when combustible construction debris is present at the construction site. Thus, protective access cover 210, comprising front cover 231 and a removable toe section 241 preferably provides an exteriorly-accessible opening to rear housing 212 for accessing refrigerant lines 14, drain line 15, and control line 16, such as during inspection, maintenance, and/or repair thereof.

Still further, toe section 241 of front panel 210 preferably acts as a bumper or buffer when machinery or personnel are operating in the vicinity of line set box 200, wherein toe section 241 extends outward from exterior wall 12 of residential house or commercial building 18, thereby barricading line set box 10 and further protecting the refrigerant lines 14, drain line 15, and control line 16 contained therein during the rough build phase construction of residential and/or commercial building 18.

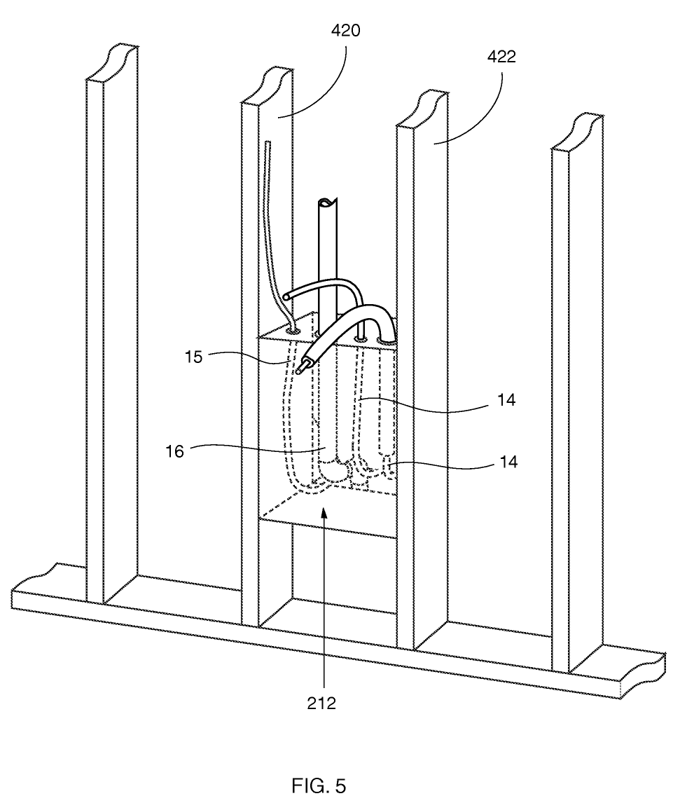

Referring now to FIG. 5, there is illustrated a perspective view of line set box 200 mounted between studs 420, 422, with refrigerant lines 14, drainage line 15, and control line 16 passing from an interior of building 18 to the exterior thereof according to an alternate embodiment of the present line set box. Refrigerant lines 14, drain line 15, and control line 16 are extended fully through line set box 200 exiting such box to the exterior of building 18 via opening 510 of toe section 241 of front panel 210. Once outside, refrigerant lines 14, drain line 15, and control line 16 are uncoiled or elongated to the compressor of the air conditioning unit located outside residential and/or commercial building 18 and connected to the compressor of such central air conditioner system.

The compressor of the central air conditioner is typically placed on a concrete pad located outside residential and/or commercial building 18. Such compressor is connected to the condenser located inside the house by refrigerant lines 14, drain line 15, and control line 16 which extend through exterior wall 12 of residential and/or commercial building 18 via line set box 200. More specifically, two refrigerant lines (typically copper lines for supplying/delivering a compressed refrigerant gas), a drain line (typically PVC pipe) and a control line (electrical line for selectively activating the compressor and fan of the air conditioning system) extend between the outside-located compressor and the inside-located condenser of the forced-air heating and cooling system and extend therefrom via line set box 10.

The foregoing description and drawings comprise illustrative embodiments of the present line set box. Having thus described exemplary embodiments of the present line set box, it should be noted by those ordinarily skilled in the art that the within disclosures are exemplary only, and that various other alternatives, adaptations, and modifications may be made within the scope of the present line set box. Many modifications and other embodiments of the line set box will come to mind to one ordinarily skilled in the art to which this line set box pertains having the benefit of the teachings presented in the foregoing descriptions and the associated drawings. Although specific terms may be employed herein, they are used in a generic and descriptive sense only and not for purposes of limitation. Accordingly, the present line set box is not limited to the specific embodiments illustrated herein, but is limited only by the following claims.

What is claimed is:

1. A line set box for protecting a plurality of air-conditioning lines of an air-conditioning unit located about an exterior of a building during construction, the line set box comprising:
a generally rigid rear housing attachable to the building;
a plurality of apertures formed through a wall of said rear housing and being configured to receive the air-conditioning lines therethrough, each aperture being sized and configured to accommodate a respective one of the air-conditioning lines; and,
a front panel removably affixed to said rear housing, wherein said front panel further comprises a cover and a toe section,
wherein engagement of said front panel with said rear housing creates an enclosure in which one or more air-conditioning line may be protected during construction of the building.

2. The line set box of claim 1, wherein the building is a residential building.

3. The line set box of claim 1, wherein the building is a commercial building.

4. The line set box of claim 1, wherein said box is attachable to the building via fasteners.

5. The line set box of claim 1, wherein said rear housing and said front panel are each fabricated from a plastic material.

6. The line set box of claim 1, wherein said rear housing and said front panel are each fabricated from a metallic material.

7. The line set box of claim 1, wherein said wall of said rear housing is fabricated from an elastomeric material.

8. The line set box of claim 1, wherein said toe section extends from said cover to create a bumper.

9. The line set box of claim 8, wherein said toe section further comprises an opening, wherein said opening enables passage of the air-conditioning lines from within said line set box to an air-conditioning unit.

10. The line set box of claim 8, wherein said rear housing is attachable to the building in a manner that said front panel faces an exterior of the building.

11. The line set box of claim 1, wherein each said aperture comprises a sealing member for forming a seal around each said aperture and the air conditioning lines, and when the air conditioning lines are accommodated through said apertures an interior of the building is sealed from any exterior elements.

12. The line set box of claim 1, wherein each of said sealing members is a grommet.

13. The line set box of claim 1, further comprising a means for releasably retaining said front panel to said rear housing.

14. A method for protecting a plurality of air-conditioning lines of an air-conditioning unit located about an exterior of a building during construction, comprising the steps of:
obtaining a line set box comprising a generally rigid rear housing having a wall and a front panel removably affixed to said rear housing, wherein said front panel comprises a cover and a toe section;
forming a plurality of apertures through said wall of said rear housing, each aperture being sized and configured to accommodate a respective one of the air-conditioning lines;
disposing each said air-conditioning line through a respective aperture;
coiling said air conditioning lines within said rear housing; and,
covering said rear housing with said front panel to protect the air conditioning lines while the building is under construction.

15. The method of claim 14, further comprising the step of attaching said rear housing to the building via fasteners.

16. The method of claim 14, further comprising the step of sealing said apertures by placing a sealing member around each said aperture and the air conditioning lines, and when the air conditioning lines are accommodated through said apertures an interior of the building is sealed from any exterior elements.

17. The method of claim 14, further comprising the step of elongating the air conditioning lines from within said line set box for connection to the air conditioning unit.
